(19) United States
(12) Patent Application Publication
(10) Pub. No.: US 2021/0001359 A1
(43) Pub. Date: Jan. 7, 2021

(54) 3-D PRINTED GAS DYNAMIC VIRTUAL NOZZLE

(71) Applicants: Richard Kirian, Tempe, AZ (US); Reza Nazari, Tempe, AZ (US); Uwe Weierstall, Phoenix, AZ (US); Ronald Adrian, Mesa, AZ (US)

(72) Inventors: Richard Kirian, Tempe, AZ (US); Reza Nazari, Tempe, AZ (US); Uwe Weierstall, Phoenix, AZ (US); Ronald Adrian, Mesa, AZ (US)

(21) Appl. No.: 16/918,807

(22) Filed: Jul. 1, 2020

Related U.S. Application Data
(60) Provisional application No. 62/869,325, filed on Jul. 1, 2019.

(51) Int. Cl. B05B 7/04; B05B 1/02

(52) U.S. Cl. CPC B05B 7/0483; B33Y 80/00; B05B 1/02

(57) ABSTRACT

A nozzle includes a chamber, a first channel formed in the nozzle, and a first passageway extending between the first channel and the chamber. The first passageway defines a first passageway axis. The nozzle also includes a second channel formed in the nozzle and a second passageway extending between the second channel and the chamber. The second passageway defines a second passageway axis, and the first passageway axis is not concentric with the second passageway axis.

### CROSS-REFERENCE TO RELATED APPLICATIONS

This application claims priority to co-pending U.S. Provisional Patent Application No. 62/869,325 filed on Jul. 1, 2019, the entire contents of which are incorporated herein by reference.

### STATEMENT REGARDING FEDERALLY SPONSORED RESEARCH OR DEVELOPMENT

This invention was made with government support under 1231306 awarded by the National Science Foundation. The government has certain rights in the invention.

### FIELD

The present disclosure relates to a nozzle, and more specifically to a gas dynamic virtual nozzle (GDVN) and a method of manufacturing the GDVN via 3-D printing.

### BACKGROUND

The creation of the free electron laser has allowed new avenues for structure determination of biological molecules. The destructive nature of these high-intensity X-ray laser pulses necessitates fast sample replenishment between pulses, which may be accomplished with a liquid jet. Gas Dynamic Virtual Nozzles (GDVN) produce microscopic flow-focused liquid jets and are widely used for injecting a stream of protein solution or protein nanocrystals into an X-ray Free Electron Laser (XFEL) for structural analysis. Some GDVNs are manufactured by hand in a tedious and non-reproducible process. Other GDVNs are manufactured via injection molding. Different versions with slightly different geometry are difficult if not impossible to achieve reproducibly, and difficult shapes, e.g. mixers and specialized nozzles are difficult or impossible to make by hand or through injection molding.

### SUMMARY

In one embodiment, a nozzle includes a chamber, a first channel formed in the nozzle, and a first passageway extending between the first channel and the chamber. The first passageway defines a first passageway axis. The nozzle also includes a second channel formed in the nozzle and a second passageway extending between the second channel and the chamber. The second passageway defines a second passageway axis, and the first passageway axis is not concentric with the second passageway axis.

In another embodiment, a nozzle includes a chamber with an outlet, a first passageway in fluid communication with the outlet, and a second passageway in fluid communication with the outlet. The second passageway includes a portion shaped as a hypodermic needle with an apex positioned at the outlet.

In another embodiment, a 3-D printed array of gas dynamic virtual nozzles includes a first nozzle with a first cavity defining a first cavity axis and a second cavity defining a second cavity axis. The array further includes a second nozzle with a third cavity defining a third cavity axis and a fourth cavity defining a fourth cavity axis. The first cavity axis, the second cavity axis, the third cavity axis, and the fourth cavity axis are all parallel and spaced apart from each other.

Other aspects of the disclosure will become apparent by consideration of the detailed description and accompanying drawings.

### BRIEF DESCRIPTION OF THE DRAWINGS

FIG. 1 is a perspective view of a nozzle according to one embodiment, coupled to capillaries.

FIG. 2 is a side view of the nozzle of FIG. 1.

FIG. 3 is a top view of the nozzle of FIG. 1.

FIG. 4 is a cross-sectional view of the nozzle of FIG. 1, taken along line 4-4 shown in

FIG. 3.

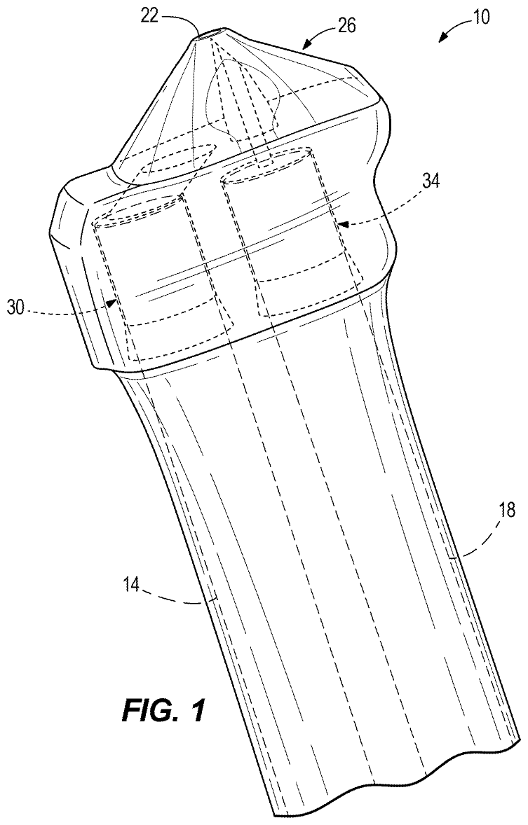

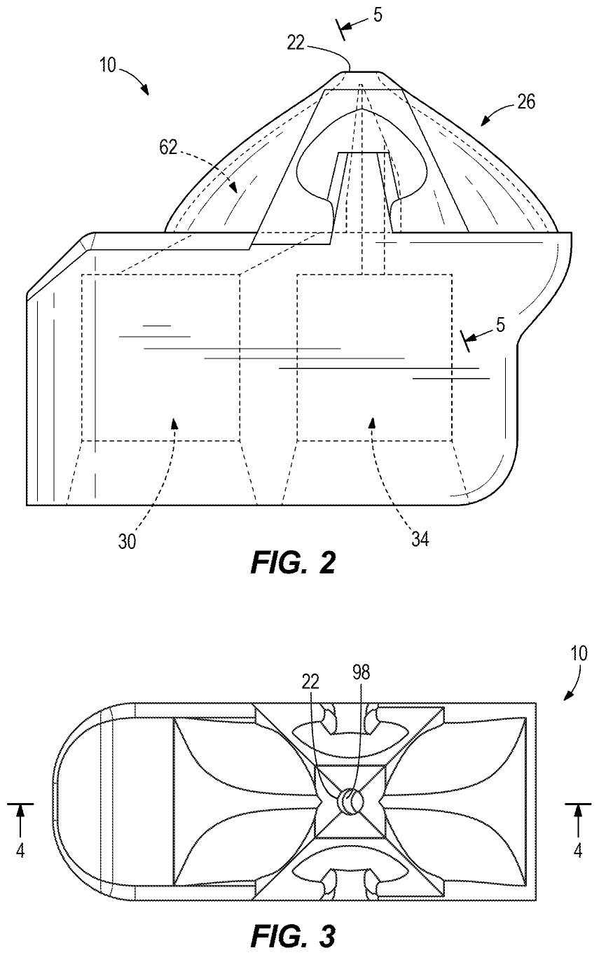

FIG. 5 is a cross-sectional view of the nozzle of FIG. 1, taken along line 5-5 shown in FIG. 2.

FIG. 6 is a detail view of the nozzle of FIG. 1, viewed along detail 6 shown in FIG. 5.

FIG. 7 is a perspective view of an array including a first nozzle and a second nozzle.

FIG. 8 is a schematic view of a nozzle with a bell-shaped chamber according to another embodiment.

FIG. 9 is a graph illustrating jet length versus helium flow rate for different liquid flow rates.

FIG. 10 is a graph illustrating jet velocity versus helium flow rate for different liquid flow rates.

FIG. 11 is a graph illustrating jet diameter versus helium flow rate for different liquid flow rates.

FIG. 12 is a graph illustrating jet angle versus helium flow rate for different liquid flow rates.

FIG. 13A is a graph illustrating the liquid jet Weber number versus the liquid jet Reynolds number.

FIG. 13B is a graph illustrating the liquid jet Weber number versus the helium flow rate.

FIG. 13C is a graph illustrating the liquid jet Reynolds number versus the helium flow rate.

FIG. 14 is a graph illustrating the estimated pressure inside of the nozzle of FIG. 1 versus the helium flow rate.

FIG. 15 is a graph illustrating calculated sheath gas Reynolds number versus helium flow rate.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

With reference to FIG. 1, a 3-D printed nozzle (i.e., flow device) 10 is shown coupled to a first capillary 14 and a second capillary 18. The nozzle 10 receives a sheath gas from the first capillary 14 and a liquid from the second capillary 18, and outputs a liquid microjet from an outlet 22 formed in a tip portion 26 (i.e., a tip) of the nozzle 10. The liquid microjet leaving the outlet 22 is utilized, for example, with an X-ray Free Electron Laser (XFEL) to measure the liquid microjet. In the illustrated embodiment, the nozzle 10 is a gas dynamic virtual nozzle (“GDVN”). The nozzle 10 is used for sample delivery in a liquid jet at XFELs or synchrotrons. GDVNs are particularly well suited to deliver biological samples to x-ray lasers for the investigation of molecular structure and dynamics.

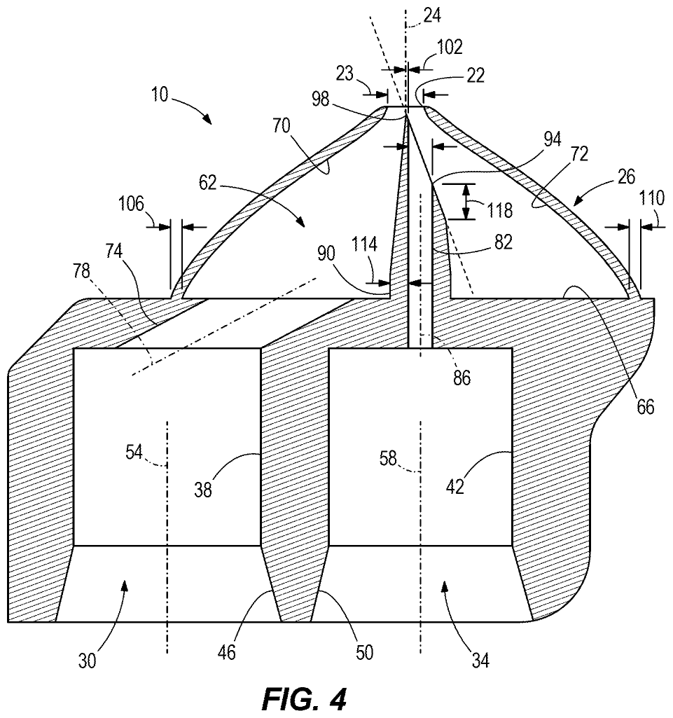

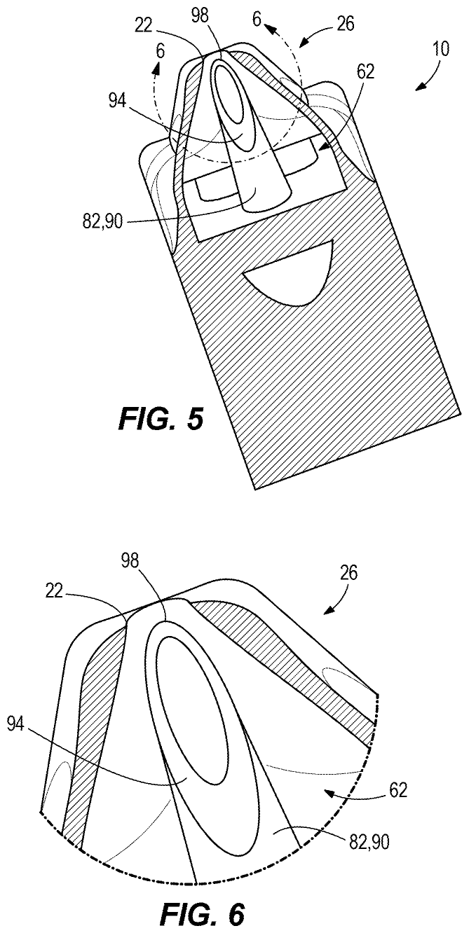

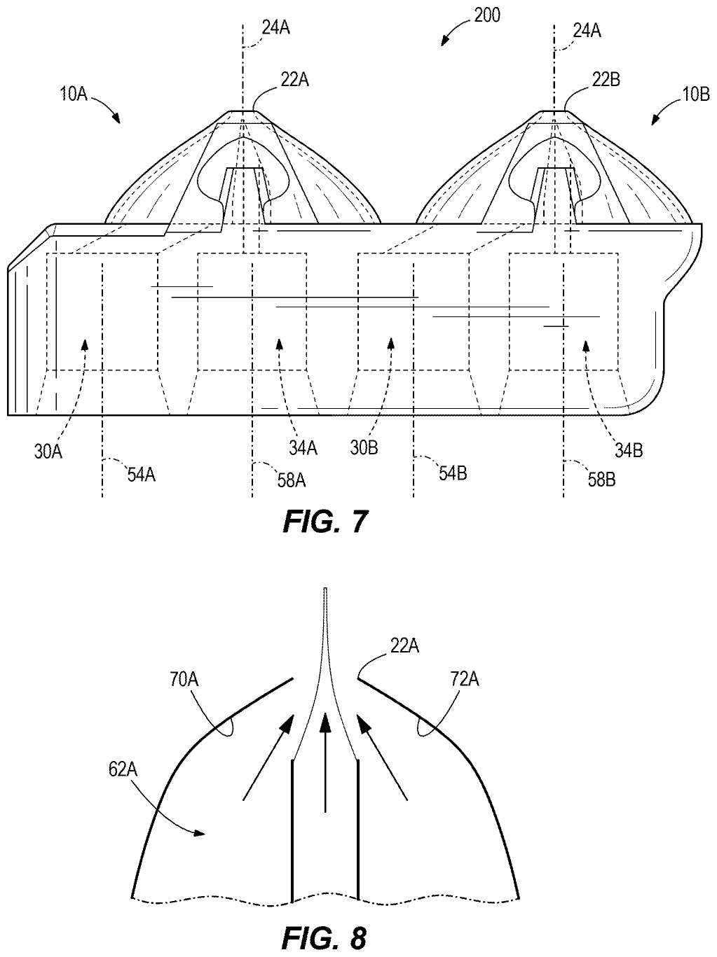

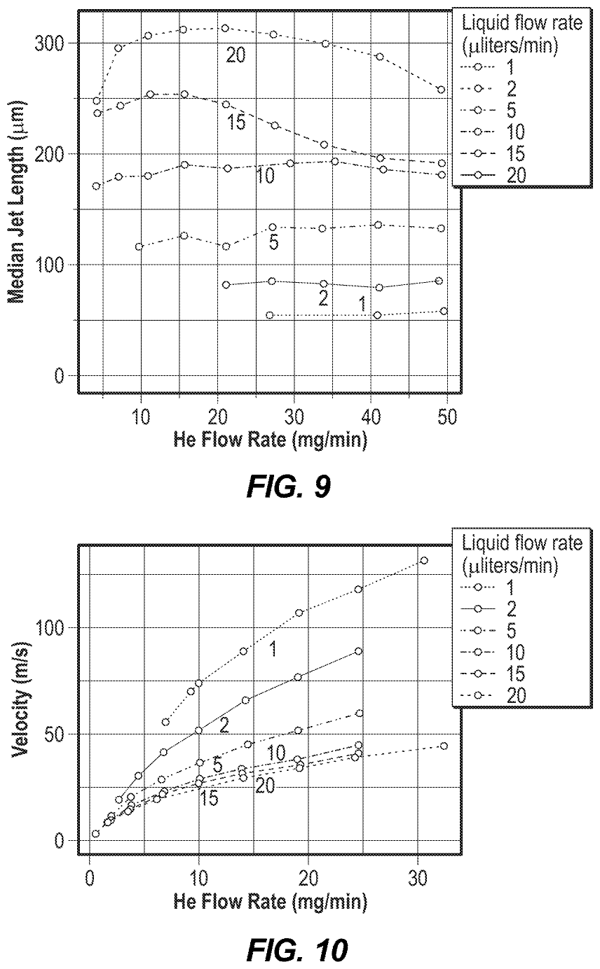

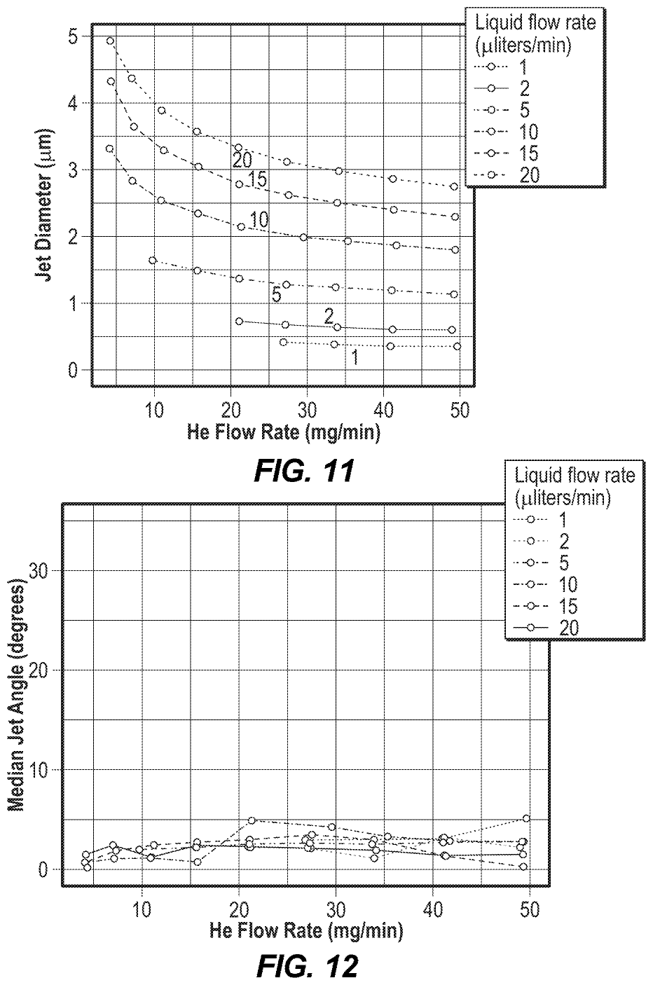

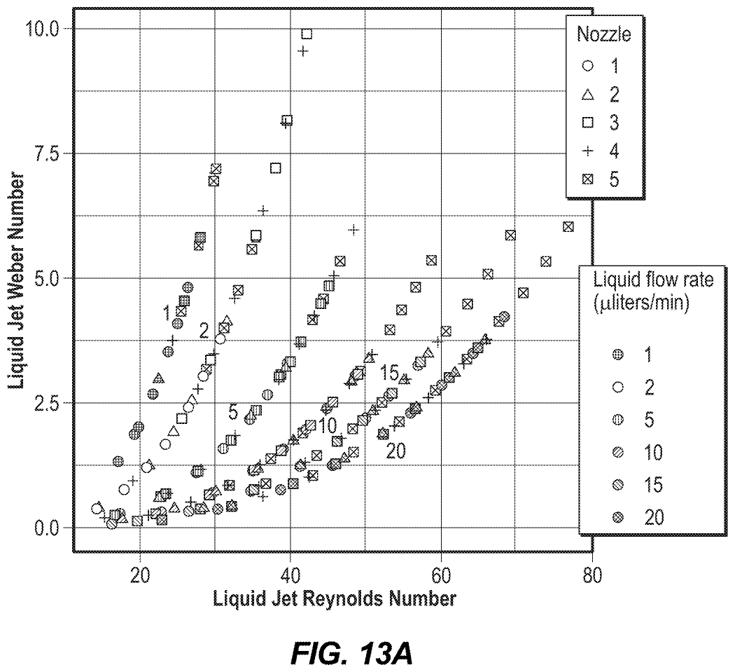

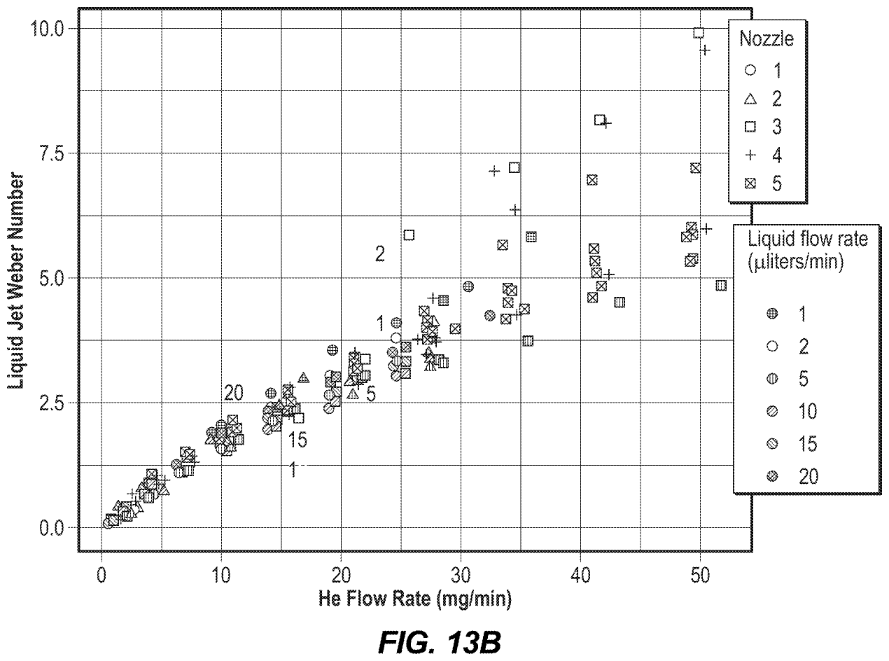

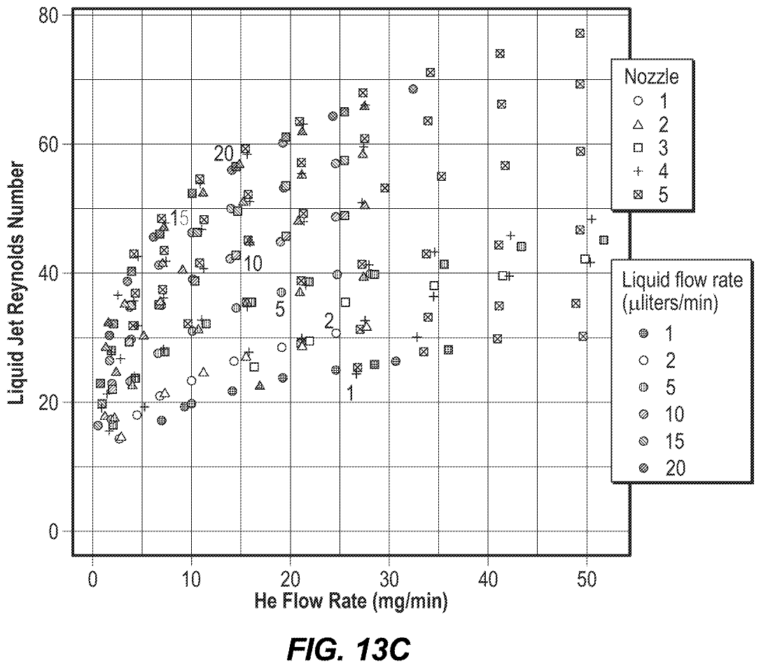

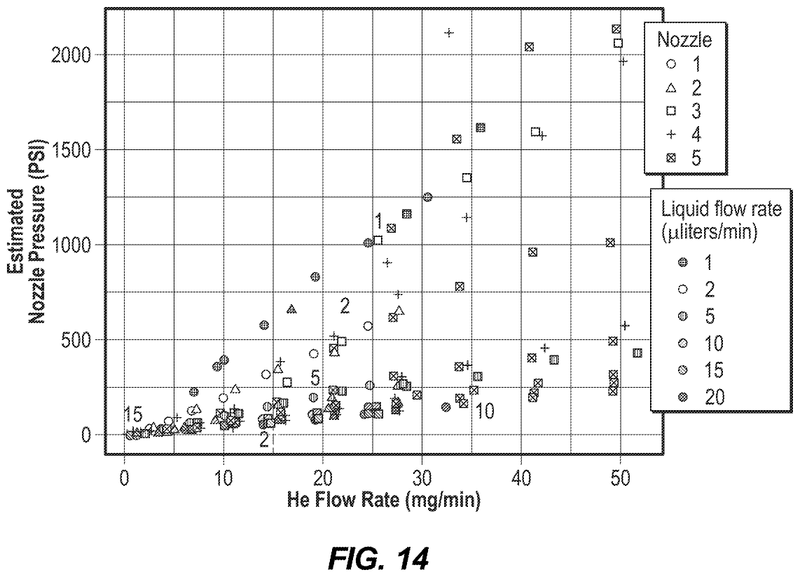

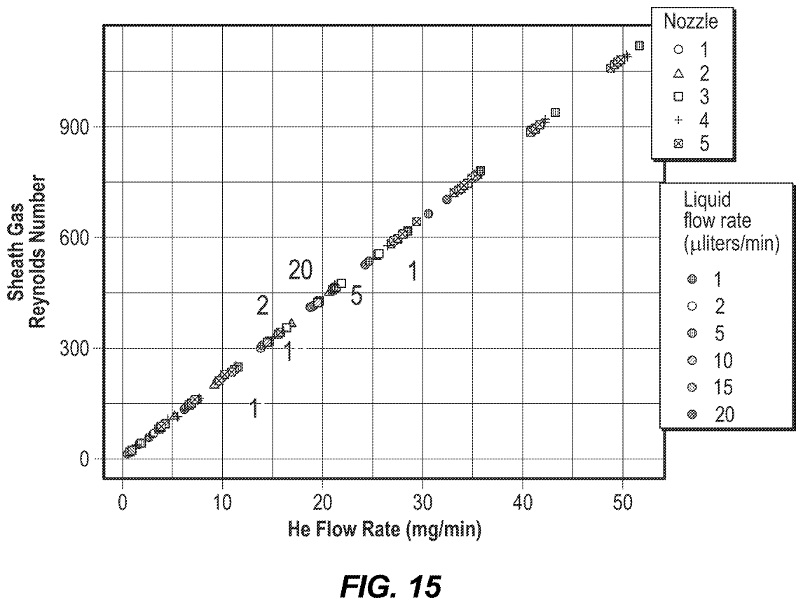

With reference to FIGS. 1 and 2, the nozzle 10 includes a first inlet channel 30 (i.e., a first inlet cavity) and a second inlet channel 34 (i.e., a second inlet cavity) formed in the nozzle 10. The first capillary 14 provides a flow of sheath gas to the first inlet channel 30 and the second capillary 18 provides a flow of a sample (e.g., a liquid sample) to the second inlet channel 34. In the illustrated embodiment, the inlet channels 30, 34 are partially defined by a circular-shaped wall 38, 42 (FIG. 4) and configured to receive the capillaries 14, 18. The inlet channels 30, 34 include a flared portion 46, 50 (FIG. 4) that increases the cross-sectional area of the inlet channel 30, 34 to facilitate the insertion of the capillaries 14, 18 into the inlet channels 30, 34.

With reference to FIG. 1, the first inlet channel 30 is configured to receive the first capillary 14. In the illustrated embodiment, the first capillary 14 is a sheath gas line, and allows a gas to flow therethrough. In other words, a sheath gas source is placed in fluid communication with the first inlet channel 30. In some embodiments, the sheath gas provided by the first capillary 14 is a Helium gas. In other embodiments, the sheath gas flowing through the first capillary 14 being supplied to the first inlet channel 30 is carbon dioxide or any other suitable sheath gas. The first capillary 14 is formed from glass but may be formed from any other suitable material.

With continued reference to FIG. 1, the second inlet channel 34 is configured to receive the second capillary 18. In the illustrated embodiment, the second capillary 18 is a liquid line, and allows a liquid to flow therethrough. In other words, a liquid source is placed in fluid communication with the second inlet channel 34. In some embodiments, the liquid flowing through the second capillary 18 is an aqueous mixture (e.g., an aqueous crystal suspension). In other embodiments, the liquid may be a fluorinated oil. In still other embodiments, the liquid may be a mixture of the aqueous crystal suspension and the fluorinated oil. The second capillary 18 is formed from glass but may be formed from any other suitable materials.

With reference to FIG. 4, the first channel 30 defines a first channel axis 54 and the second channel 34 defines a second channel axis 58. In the illustrated embodiment, the first channel axis 54 is parallel to the second channel axis 58. More specifically, the first channel axis 54 is parallel to and spaced apart from the second channel axis 58 (i.e., the first channel axis 54 is not concentric with the second channel axis 58). In other words, the first channel 30 is parallel to and spaced apart from the second channel 34. With the first inlet channel 30 spaced from the second inlet channel 34, the two capillaries 14, 18 may be easily coupled to the nozzle 10. The spaced apart inlet channels 30, 34 allows for simple, separate capillaries 14, 18 to be utilized, thereby simplifying the setup for the input sheath gas and liquid.

With continued reference to FIGS. 1-4, the tip portion 26 of the nozzle 10 includes a chamber 62 defined therewithin (i.e., a central cavity). The outlet opening 22 formed at the apex of the tip portion 26 (FIG. 3) has a diameter 23 and defines an outlet axis 24 (FIG. 4). The diameter 23 of the outlet 22 is within a range of approximately 110 microns (i.e., micrometers) and approximately 90 microns. In other embodiments, the diameter 23 is approximately 100 microns. Other embodiments include other values and ranges. The outlet opening 22 is in fluid communication with the chamber 62. Both the first inlet channel 30 and the second inlet 34 channel are in fluid communication with the chamber 62 and the outlet opening 22. In particular, the first inlet channel 30 and the second inlet channel 34 are positioned upstream from the chamber 62.

With continued reference to FIG. 4, the chamber 62 is partially defined by a floor surface 66. The chamber 62 is partially defined by a first arcuate surface 70 that extends between the floor surface 66 and the outlet 22 and a second arcuate surface 72 that extends between the floor surface 66 and the outlet 22. The chamber 62 is bell-shaped. FIG. 8 illustrates an alternative nozzle 10a with a bell-shaped chamber 62A that is partially defined by a first arcuate surface 70A that extends between a floor surface and the outlet 22A and a second arcuate surface 72A that extends between the floor surface and the outlet 22. In general, chambers 62, 62a with the arcuate surfaces 70, 70A, 72, 72A leading to the outlet 22, 22A result in greater jet stability at the outlets 22, 22A when compared to nozzles with linear surfaces (e.g., on a conical-shaped chamber).

With continued reference to FIG. 4, a first passageway 74 extends between the first channel 30 and the chamber 62. The first passageway 74 defines a first passageway axis 78. The first passageway 74 is positioned downstream of the first channel 30 and places the first channel 30 in fluid communication with the chamber 62 and the outlet 22. The first channel 30 receives the first capillary 14, but the first capillary 14 is unable to pass into the smaller diameter of the first passageway 74. The first passageway 74 extends to the chamber 62 and provides a fluid pathway for the gas from the first capillary 14 to flow into the tip portion 26. In the illustrated embodiment, the first passageway 74 is inclined with respect to the first channel 30. In other words, the first channel axis 54 and the first passageway axis 78 intersect at a point. In other embodiments, the first passageway is parallel to the first channel 30.

Likewise, a second passageway 82 extends between the second channel 34 and the chamber 62. The second passageway 82 defines a second passageway axis 86. The second passageway 82 is positioned downstream of the second channel 34 and places the second channel 34 in fluid communication with the chamber 62 and the outlet 22. The second channel 34 receives the second capillary 18, but the second capillary 18 is unable to pass into the smaller diameter of the second passageway 82. The second passageway 82 extends to the chamber 62 and provides a fluid pathway for the liquid from the second capillary 18 to flow into the tip portion 26. In the illustrated embodiment, the second channel 34 and the second passageway 82 are aligned. In other words, the second channel axis 58 is concentric with the second passageway axis 86, which helps prevent clogging from occurring in the second channel 34 and second passageway 82.

The first passageway axis 78 is not concentric with the second passageway axis 86. In the illustrated embodiment, the first passageway axis 78 interests the second passageway axis 86 at a single point of intersection. In other words, the first passageway 74 is angled with respect to the second passageway 82 in the illustrated embodiment. In alternative embodiments, the first passageway axis is parallel and spaced apart from (i.e., not concentric with) the second passageway.

The first passageway 74 terminates at the floor surface 66, but the second passageway 82 extends into the chamber 62. The second passageway 82 is partially defined by a wall portion 90 extending away from the floor surface 66. In the illustrated embodiment, the wall portion 90 is circular and the wall portion 90 is shaped as a hypodermic needle. In particular, the second passageway 82 defines an end surface 94, and the end surface 94 is non-parallel to the floor surface 66 (i.e., the end surface 94 is angled with respect to the floor surface 66). In other words, the end surface 94 (FIGS. 5 and 6) creates an asymmetric tip at the end of the second passageway 82. The second passageway 82 defines an apex 98 on the end surface 94, and the apex 98 is positioned at the outlet 22. In some embodiments, the apex 98 is positioned proximate to the outlet 22. The distance between the apex 98 and the center of the outlet 22 defines a dimension 102 (FIG. 4). In the illustrated embodiment, the dimension 102 is within a range of approximately 7 microns and approximately 0 microns. In other embodiments, the dimension 102 is approximately 5 microns. Other embodiments include different values and ranges.

In operation, gas from the first capillary 14 and liquid from the second capillary 18 mix in the central chamber cavity 62. The liquid is focused into a jet (e.g., a microjet) by the gas. The microjet then exits the nozzle 10 through the outlet opening 22. An XFEL beam can then be used to contact the microjet of material exiting the nozzle 10. Contact with the XFEL beam may cause the microjet to scatter and allows the protein crystal structure of the crystals to be observed, measured, and determined. In addition to being used with XFEL, the nozzle 10 may be used in other applications that include, but are not limited to, the food industry, the pharmaceutical industry (e.g., with drug delivery, biomedicine, etc.), and mass spectroscopy (e.g., to replace electrospray).

The end surface 94 of the second passageway 82 reduces the flow rate of the liquid through the second passageway 82. For example, the liquid may have a flow rate of less than 2 μL/min through the second passageway 82. The liquid may alternatively have a flow rate of approximately 0.35 μL/min. Other embodiments include different flow rates. The asymmetric tip of the second passageway 82 provides a smaller jet of liquid than a similarly sized passageway with a symmetric tip (i.e., a flat, non-angled end surface). A smaller jet increases the stability of the jet of liquid and reduce the jet jitter of the jet of liquid flowing through the second passageway 82. In addition, the smaller jet provides a gas-free expansion jet.

The nozzle 10 may be produced (i.e., manufactured, formed, fabricated) using 3-D printing (i.e., 3-D manufacturing, 3-D additive manufacture). This allows for miniaturization and modification of the nozzle 10, which in turn allows for simple adjustment of structural parameters. The nozzle 10 provides greater flexibility in size and allows for an increased range of jet diameters and jet speeds over what was possible with nozzles produced in other traditional methods (e.g., by hand). In other words, the nozzle 10 is made with complex geometries (e.g., geometries that could not be made by hand). 3-D printing the nozzle 10 creates a single monolithic component. Different nozzles 10 can be 3-D printed and tailored to various fluid properties (e.g., viscosity, chemical composition, etc.) of the desired application. The nozzle 10 allows for production of highly monodispersed droplets where the size distribution has a standard deviation of roughly 5% of a mean value. The nozzle 10 may be made by 3-D printing in order to also assist with efficient reproduction. 3-D printing the nozzle 10 also allows the liquid microjets formed at the outlet 22 to be generated in a highly reproducible way. In other words, the microjets generated by the nozzle 10 have greater stability and can be utilized with a broader range of liquid flow rates and jet speeds.

In the illustrated embodiment, the nozzle 10 is comprised of IP-S photoresist material that is printed in batches with a Photonic Professional (GT) laser lithography printer (˜200-nm resolution). Each nozzle 10 requires a printing time of a few minutes to a few hours, depending on the design. Once the 3-D printing process has completed the nozzle 10, the first and second capillaries 14, 18 may then be attached to the inlet channels 30, 34 with epoxy.

3-D printing allows dimensions to be achieved for the nozzle 10 that may otherwise not be achievable with traditional manufacturing methods. For example, as illustrated in FIG. 4, the outer wall of the chamber 62 defines a first wall thickness dimension 106 and a second wall thickness dimension 110. In the illustrated embodiment, the dimension 106 and the dimension 110 are within a range of approximately 20 microns to approximately 25 microns. In other embodiments, the dimensions 106, 110 are approximately 23 microns, or other values and ranges. In the illustrated embodiment the dimensions 106, 110 are equal. In other embodiments, dimensions 106, 110 are not equal. A dimension 114 defines the thickness of the wall portion 90 of the second passageway 82. In the illustrated embodiment, the dimension 114 is within a range of approximately 35 microns to approximately 45 microns. In other embodiments, the dimension 114 is approximately 40 microns, or other values and ranges. A dimension 118 is the height of a bottom portion of the angled end surface 94. In the illustrated embodiment, the dimension 118 is within a range of approximately 57 microns to approximately 77 microns. In other embodiments, the dimension 118 is approximately 67 microns, or other values and ranges.

In some embodiments, the nozzle 10 is fabricated by a 3D-printer (e.g., a 2-photon polymerization with a Nanoscribe 3D-printer), which creates the nozzle 10 as one single, monolithic device. The nozzle 10 may have a diameter, for example, of approximately 150 microns or approximately 360 microns, although other embodiments include different diameters and ranges of diameters. The nozzle 10 may ideally have a diameter between approximately 10 microns and approximately 400 microns. In the illustrated embodiment, the first channel 14 has a diameter between approximately 10 microns and approximately 400 microns, and more specifically a dimeter of approximately 100 microns. The second channel 18 has a diameter between approximately 10 microns and approximately 400 microns, and more specifically a diameter of approximately between 20-50 microns. In other embodiments, the channels 30, 34 are of a different size than the other.

With reference to FIG. 7, multiple nozzles 10A, 10B may be 3-D printed together in a single, unitary array 200. The 3-D printed array 200 includes multiple nozzles 10A, 10B connected in parallel. The nozzles 10A, 10B are substantially the same as the nozzle 10 illustrated in FIGS. 1-6, but redundant reference numerals have been omitted. Because nozzle 10A, 10B geometry is reproducible with accuracy on the sub-micron scale, multiple nozzles 10A, 10B can be formed simultaneously with low turnover time. The array 200 may be connected to multiple sets of first and second capillaries 14, 18 and mounted in an experimental chamber, for example. This allows fast switching over to a new nozzle 10A or 10B in the array 200 if one is clogged. In the illustrated embodiment, the array 200 is formed as a monolithic piece (e.g., each nozzle 10A, 10B is integrally formed in one piece with the other nozzles 10A, 10B in the array 200). In other embodiments, the array 200 may be formed as separate pieces (e.g., each nozzle is coupled together but not formed as an integral piece).

With continued to FIG. 7, the array 200 includes the first nozzle 10A with a first channel 30A defining a first channel axis 54A and a second channel 58A defining a second channel axis 58A. The array 200 also includes the second nozzle 10B with a third channel 30B defining a third channel axis 54B and a fourth channel 34B defining a fourth channel axis 58B. In the illustrated embodiment, the first channel axis 54A, the second channel axis 58A, the third channel axis 54B, and the fourth channel axis 58B are all parallel and spaced apart from each other (i.e., non-concentric). Each of the first channel 30A, the second channel 34A, the third channel 30B, and the fourth channel 34B are configured to be coupled with a capillary tube (for example the capillaries 14, 18). The first channel 30A and the second channel 34A are in fluid communication with a first outlet 22A formed in the first nozzle 10A. The third channel 30B and the fourth channel 34B are in fluid communication with a second outlet 22B formed in the second nozzle 10B.

In use, the nozzle 10 may supply a helium (or other sheath gas) flow rate based on a liquid flow rate through the second channel 34. The helium flow rate can also be dependent on upstream pressures, pressure head loss, and nozzle geometry. The values can be used to determine the jet length of the nozzle 10 (e.g., a length of a fluid stream extending from the nozzle 10). Sufficient jet length is important in an XFEL experiment such that the refracted beam does not collide with the nozzle 10, and damage the nozzle 10 or negatively affect the data collection. As shown in FIG. 9, as the liquid flow rate is kept constant and the helium flow rate increases, the jet length increases to a maximum value, before slightly decreasing afterwards.

A high jet speed (e.g., the velocity of fluid exiting the nozzle 10 in a fluid stream) is also important in XFEL experiments because after a laser pulse hits the jet, the jet should be fast enough to replenish the material for the next laser pulse. As shown in FIG. 10, the jet speed is directly dependent on the helium flow rate, and inversely related to the liquid flow rates. In other words, the fastest jets may be achieved when the liquid flow rate is relatively low.

A jet diameter may be obtained by dividing the liquid flow rate by the estimated nozzle velocity. As shown in FIG. 11, the jet diameter is dependent on the liquid flow rate. The jet diameter can therefore be adjusted by varying the liquid flow rate, while the helium flow rate plays only a secondary role in determining jet diameter. In the illustrated embodiment, this is mostly true for helium flow rates above 20 mg/min, which represent the dominant operating conditions for XFEL experiments.

In the illustrated embodiment, the jet needs to be relatively straight as it exits the nozzle 10 so that it does not collide with sidewalls in XFEL experiments. The jet deviation angle needs to be minimized in order to prevent accumulation on the sidewalls and necessitate the XFEL experiment to be stopped so that the sidewalls can be cleaned. As shown in FIG. 12, the jet deviation angle is less than about 12° in order to prevent collision of the jet with the sidewall. In other embodiments, the jet deviation angle may be greater or less than 12°.

In order to estimate the pressure inside the nozzle 10, the Reynolds number (Eqn. 1, below) and the Weber Number (Eqn. 2, below) for the liquid jet may be used. In the equations, p is the liquid density, Q is the volumetric flow rate of the liquid, R is the jet diameter estimated in FIG. 11, and σ is the surface tension of the liquid.

$$\begin{matrix}R e = \frac{ρ Q}{π R μ} & ( 1 ) \\ WE = \frac{ρ {Q}^{2}}{{π}^{2} {R}^{3} σ} & ( 2 )\end{matrix}$$

These values are plotted in FIGS. 13A-13C. When the comparative effects of inertial forces would be sufficiently large, in the regimes that Re≥10 and We≥1 the effects of surface tension and viscosity on energy sink can be neglected. Thus, one can balance the rate of energy injected to the system by pressure drop from inside the nozzle to the vacuum chamber with the rate of increase of jet kinetic energy to estimate jet radius (Eqn. 3).

$$R = {( \frac{ρ {Q}^{2}}{2 {π}^{2} Δ P} )}^{1 / 4} \qquad ( 3 )$$

The jet radius and the jet velocity may be calculated. The pressure difference may be calculated between the inside of the nozzle 10 and a vacuum chamber. If the pressure inside the vacuum chamber is ignored (i.e., because the pressure value is negligible), the pressure inside the nozzle 10 can be calculated using the following equations.

$$\begin{matrix} kinetic Energy Rate = \dot{KE} = \dot{m} {v}^{2} / 2 = Q ρ {v}^{2} / 2 & ( 4 ) \\ Q = Av \to \frac{Q}{A} = \frac{Q}{π {R}^{2}} & ( 5 ) \\ Rate of Change of Energy from Pressure Difference = Δ PA \frac{Δ x}{Δ t} = Δ P A v = Δ PQ & ( 6 ) \\ Q Δ P = Q \frac{Q ρ {v}^{2}}{2} \to Δ P = \frac{ρ {v}^{2}}{2} \to Δ P = \frac{ρ}{2} {( \frac{Q}{π {R}^{2}} )}^{2} & ( 7 )\end{matrix}$$

As shown in FIG. 14, the nozzle 10 pressure is illustrated for different operating conditions. Because the area downstream of the nozzle 10 is the vacuum chamber, the calculated ΔP value equals the pressure inside of the nozzle 10.

Different sheath gases (e.g., carbon dioxide) were also tested to determine the effects on jet characteristics. As shown in FIG. 15, using carbon dioxide can achieve similar flow focusing liquid jet conditions with less sheath gas flow rate compared with the conditions when the sheath gas is helium.

Although aspects have been described in detail with reference to certain preferred embodiments, variations and modifications exist within the scope of one or more independent aspects as described.

What is claimed is:

1. A nozzle comprising:
a chamber;
a first channel formed in the nozzle;
a first passageway extending between the first channel and the chamber, wherein the first passageway defines a first passageway axis;
a second channel formed in the nozzle;
a second passageway extending between the second channel and the chamber, wherein the second passageway defines a second passageway axis;
wherein the first passageway axis is not concentric with the second passageway axis.

2. The nozzle of claim 1, wherein the first channel defines a first channel axis and the second channel defines a second channel axis; and wherein the first channel axis is parallel to the second channel axis.

3. The nozzle of claim 2, wherein the second passageway axis is aligned with the second channel axis.

4. The nozzle of claim 2, wherein the first passageway axis is non-parallel to the first channel axis.

5. The nozzle of claim 1, wherein the chamber includes an outlet, and wherein the chamber is partially defined by a floor surface.

6. The nozzle of claim 5, wherein the chamber is partially defined by an arcuate surface that extends between the floor surface and the outlet.

7. The nozzle of claim 5, wherein the first passageway terminates at the floor surface and the second passageway extends into the chamber.

8. The nozzle of claim 7, wherein the second passageway is partially defined by a wall portion extending away from the floor surface.

9. The nozzle of claim 8, wherein the wall portion is circular.

10. The nozzle of claim 8, wherein the wall portion is shaped as a hypodermic needle.

11. The nozzle of claim 7, wherein the second passageway defines an end surface; and wherein the end surface is non-parallel to the floor surface.

12. The nozzle of claim 7, wherein the second passageway defines an apex; and wherein the apex is positioned at the outlet.

13. The nozzle of claim 1, wherein the nozzle is a gas dynamic virtual nozzle.

14. The nozzle of claim 1, wherein the nozzle is formed by three-dimensional printing.

15. A nozzle comprising:
a chamber with an outlet;
a first passageway in fluid communication with the outlet; and
a second passageway in fluid communication with the outlet;
wherein the second passageway includes a portion shaped as a hypodermic needle with an apex positioned at the outlet.

16. The nozzle of claim 15, wherein the first passageway terminates at the chamber and wherein the second passageway extends into the chamber.

17. The nozzle of claim 16, wherein the chamber is partially defined by an arcuate surface that extends between a floor surface and the outlet.

18. A 3-D printed array of gas dynamic virtual nozzles comprising:
a first nozzle with a first channel defining a first channel axis and a second channel defining a second channel axis;
a second nozzle with a third channel defining a third channel axis and a fourth channel defining a fourth channel axis;
wherein the first channel axis, the second channel axis, the third channel axis, and the fourth channel axis are all parallel and spaced apart from each other.

19. The 3-D printed array of gas dynamic virtual nozzles of claim 18, wherein each of the first channel, the second channel, the third channel, and the fourth channel are configured to be coupled with a capillary tube.

20. The 3-D printed array of gas dynamic virtual nozzles of claim 18, wherein the first channel and the second channel are in fluid communication with a first outlet formed in the first nozzle, and wherein the third channel and the fourth channel are in fluid communication with a second outlet formed in the second nozzle.
